(19) United States
(12) Patent Application Publication
(10) Pub. No.: US 2021/0364073 A1
(43) Pub. Date: Nov. 25, 2021

(54) HYDRAULIC ROTATION ASSEMBLY AND METHOD

(71) Applicant: B.C. BIKE, Ltd., Kibbutz Netiv HaLamed-Heh (IL)

(72) Inventor: Aryeh HOUMINER, Luzit (IL)

(21) Appl. No.: 16/961,702

(22) PCT Filed: Dec. 30, 2018
(86) PCT No.: PCT/IL2018/051414

§ 371 Date: Jul. 13, 2020

Related U.S. Application Data
(60) Provisional application No. 62/617,235, filed on Jan. 14, 2018.

(51) Int. Cl. F16H 39/20; B62M 19/00; F15B 15/20

(52) U.S. Cl. CPC F16H 39/20; F15B 15/20; B62M 19/00

(57) ABSTRACT

A hydraulic assembly comprising: a rotational member; a plurality of hydraulic chambers arrayed about a center axis, each of the plurality of hydraulic chambers exhibiting a first end, a second end, a wall extending from the first end to the second end and an opening along the wall between the first end and the second end; and a plurality of pistons each positioned within a respective one of the plurality of hydraulic chambers, wherein each of the plurality of pistons further comprises a protrusion protruding from a side of the piston, the protrusion of each of the plurality of pistons extending, through the opening of the respective hydraulic chamber and arranged to contact the rotational member such that a force is applied between the rotational member and the respective piston.

### CROSS-REFERENCE TO RELATED APPLICATIONS

The present application claims priority from U.S. provisional patent application Ser. 62/617,235 filed Jan. 14, 2018 and entitled “HYDRAULIC ROTATION ASSEMBLY AND METHOD”, the entire contents of which incorporated herein by reference.

### FIELD OF THE INVENTION

The invention relates generally to the field of hydraulics, and in particular to a hydraulic assembly and method which reduces the size and weight requirements of the assembly while maintaining the desired hydraulic properties.

### BACKGROUND OF THE INVENTION

In bicycles, the traditional mechanism for transmitting power from the rider to a motive wheel is a chain drive wherein a drive sprocket is attached to the pedals of the bicycle and a driven sprocket is attached to the rear wheel. A chain is engaged with the teeth of the sprockets such that rotation of the pedals in a first direction induces the rear wheel to turn. It has also become quite common for bicycles to incorporate gear change apparatus to select from a set of available gear ratios between the driven sprocket and the drive sprocket. This is normally accomplished by providing a plurality of progressively larger driven sprockets at the rear wheel and a number of drive sprockets coupled to the pedals. Movable chain guides in conjunction with a derailleur allow the bicyclist to select which sprockets are utilized by positioning the drive chain over the correct sprocket pair via levers and cables.

While the traditional bicycle chain drive has served its purposes well over the years, it does have certain limitations of functionality and safety. For example, in order to reduce weight, chain drives are typically exposed, creating a safety risk to the rider in the form of entangling clothing in the chain and sprocket. Selectable ratio bicycle transmissions are prone to shifting to the wrong gear and to positioning the chain in an intermediate position between sprockets, which can cause the chain to slip, consequently causing an imbalance of the cyclist. Additionally, because the chain and sprocket require lubrication, they become a magnet for dust and dirt which impedes efficient power transmission, wears the chain and sprockets and frequently stains clothing that contacts it. Furthermore, changing gears is an unpleasant and sometimes difficult process, which requires skill to do properly. Additionally, regular maintenance of the transmission is required.

In order to overcome these disadvantages, bicycles have been developed with hydraulic drive systems. For example, U.S. Pat. No. 5,938,224, issued Aug. 17, 1999 to Brackett, the entire contents of which are incorporated herein by reference, is addressed to a chainless bicycle driven by a hydraulic system powered by the pedals of the bicycle. Although many years have passed, hydraulic driven bicycles still haven't become widespread. One of the major reasons for this is that hydraulic pumps and motors tend to be too large, bulky and heavy to be efficiently and aesthetically used in a standard sized bicycle, while maintaining a predetermined hydraulic displacement and efficiency. For example, providing a uniform displacement generally requires a hydraulic accumulator, which further adds to the size and weight of the assembly.

There is thus a long felt need for a hydraulic system which can drive a bicycle with desired hydraulic properties, while being small and light enough to use in standard sized bicycles.

### SUMMARY

Accordingly, it is a principal object of the present invention to overcome at least some of the disadvantages of the prior art. In one embodiment, this is provided by a hydraulic assembly comprising: at least one rotational member exhibiting a first center axis; a plurality of hydraulic chambers arrayed about a second center axis, each of the plurality of hydraulic chambers exhibiting a first end facing the second center axis, a second end opposing the first end, a wall extending from the first end to the second end and at least one opening along the wall between the first end and the second end; and a plurality of pistons, each exhibiting a first end a second end and a side extending from the first end to the second end, each of the plurality of pistons positioned within a respective one of the plurality of hydraulic chambers, wherein each of the plurality of pistons further comprises at least one protrusion protruding from the side of the piston, the at least one protrusion of each of the plurality of pistons extending through the at least one opening of the respective hydraulic chamber and arranged to contact the at least one rotational member such that a force is applied between the at least one rotational member and the respective piston.

In one embodiment, the applied force rotates the plurality of hydraulic chambers about the second center axis or rotates the at least one rotational member about the first center axis. In another embodiment, the force is applied responsive to one of: a rotation of the at least one rotational member about the first center axis; and a rotation of the plurality hydraulic chambers about the second center axis.

In one embodiment, the at least one protrusion of each of the plurality of pistons contacts the at least one rotating member between the first end and the second end of the respective hydraulic chamber. In another embodiment, the at least one rotational member comprises at least one cam.

In one embodiment, the plurality of hydraulic chambers comprises a first set of hydraulic chambers arrayed about the second center axis and a second set of hydraulic chambers arrayed about the second center axis such that each of the first set of hydraulic chambers is generally parallel to a respective one of the second set of hydraulic chambers, and wherein the piston of each of the first set of hydraulic chambers is secured to the piston of the respective one of the second set of hydraulic chambers, the at least one rotational member positioned between the pistons of the first set of hydraulic chambers and the pistons of the second set of hydraulic chambers. In one further embodiment, the piston of each of the first set of hydraulic chambers is secured to the piston of the respective one of the second set of hydraulic chambers via the respective protrusions.

In another embodiment, the at least one opening of each of the plurality of hydraulic chambers comprises a first opening and a second opening, the second opening opposing the first opening, wherein the at least one protrusion of each of the plurality of pistons comprises a first protrusion and a second protrusion, the second protrusion opposing the first protrusion, the first protrusion protruding through the first opening of the respective hydraulic chamber and the protrusion protruding through the second opening of the respective hydraulic chamber, and wherein the at least one rotational member comprises a pair of rotational members positioned in parallel to each other, the plurality of pistons positioned between the pair of rotational members such that the first protrusion of each of the plurality of pistons is arranged to come in contact with a first of the pair of rotating members and the second protrusion of each of the plurality of pistons is arranged to come in contact with a second of the pair of rotating members.

In one embodiment, the at least one protrusion of each of the plurality of pistons comprises a generally circular shaped portion, the contact with the at least one rotating member being via the generally circular shaped portion. In another embodiment, the at least one rotational member comprises a first rotational member and a second rotational member, and wherein the at least one protrusion of each of the plurality of pistons is arranged to contact the first rotational member such that a force is applied between the first rotational member and the respective piston in a first direction and the at least one protrusion of each of the plurality of pistons is arranged to contact the second rotational member such that a force is applied between the second rotational member and the respective piston in a second direction, the second direction generally opposing the first direction.

In one independent embodiment, a hydraulic rotation method is provided for rotating at least one rotational member about a first center axis or rotating a plurality of hydraulic chambers about a second center axis, the plurality of hydraulic chamber arrayed about the second center axis, each of the plurality of hydraulic chambers having disposed therein a respective one of a plurality of pistons, the method comprising applying a force between each of the plurality of pistons and the at least one rotational member, wherein the force is applied between the at least one rotational member and at least one point on a side of each of the plurality of pistons, the at least one point being between a first end and second end of the respective one of the plurality of hydraulic chambers.

In one embodiment, the applied force rotates the plurality of hydraulic chambers about the second center axis or rotates the at least one rotational member about the first center axis. In another embodiment, the force is applied responsive to one of: a rotation of the at least one rotational member about the first center axis; and a rotation of the plurality hydraulic chambers about the second center axis.

In one embodiment, the at least one rotational member comprises at least one cam. In another embodiment, for each of the plurality of pistons, the force is applied through at least one opening in a side of the respective hydraulic chamber.

In one embodiment, for each of the plurality of pistons, the force is applied via at least one protrusion protruding from the respective piston through the at least one opening of the respective hydraulic chamber. In another embodiment, the plurality of hydraulic chambers comprises a first set of hydraulic chambers arrayed about the second center axis and a second set of hydraulic chambers arrayed about the second center axis such that each of the first set of hydraulic chambers is generally parallel to a respective one of the second set of hydraulic chambers, wherein the piston of each of the first set of hydraulic chambers is secured to the piston of the respective one of the second set of hydraulic chambers, the at least one rotating member positioned between the pistons of the first set of hydraulic chambers and the pistons of the second set of hydraulic chambers.

In one embodiment, the at least one point comprises a first point and a second point, the second point opposing the first point, wherein the at least one rotational member comprises a pair of rotational members positioned in parallel to each other, the plurality of pistons positioned between the pair of rotational members such that a first portion of the force is applied between a first of the pair of rotational members and the first point of each of the plurality of pistons and a second portion of the force is applied between a second of the pair of rotational members and the second point of each of the plurality of pistons. In another embodiment, the at least one rotational member comprises a first rotational member and a second rotational member, wherein the force is applied by the first rotational member in a first direction and is applied by the second rotational member in a second direction, the second direction generally opposing the first direction.

Additional features and advantages of the invention will become apparent from the following drawings and description.

### BRIEF DESCRIPTION OF THE DRAWINGS

For a better understanding of various embodiments of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIGS. 1A-1L illustrate various high level views of a first embodiment of a first hydraulic assembly;

FIG. 1M illustrates a high level schematic view of the reactive forces applied to a piston of a prior art hydraulic assembly;

FIG. 1N illustrates a high level schematic view of the reactive forces applied to a piston in accordance with certain embodiments;

FIGS. 2A-2B illustrate various high level views of a second embodiment of the first hydraulic assembly of FIGS. 1A-1L;

FIGS. 3A-3E illustrate various high level views of a second hydraulic assembly, in accordance with certain embodiments;

FIGS. 4A-41 illustrate various high level views of a third hydraulic assembly, in accordance with certain embodiments;

FIG. 5 illustrates a hydraulic bicycle, in accordance with certain embodiments; and

FIG. 6 illustrates a high level flow chart of a hydraulic rotation method, in accordance with certain embodiments.

### DETAILED DESCRIPTION

Before explaining at least one embodiment in detail, it is to be understood that the invention is not limited in its application to the details of construction and the arrangement of the components set forth in the following description or illustrated in the drawings. The invention is applicable to other embodiments being practiced or carried out in various ways. Also, it is to be understood that the phraseology and terminology employed herein is for the purpose of description and should not be regarded as limiting.

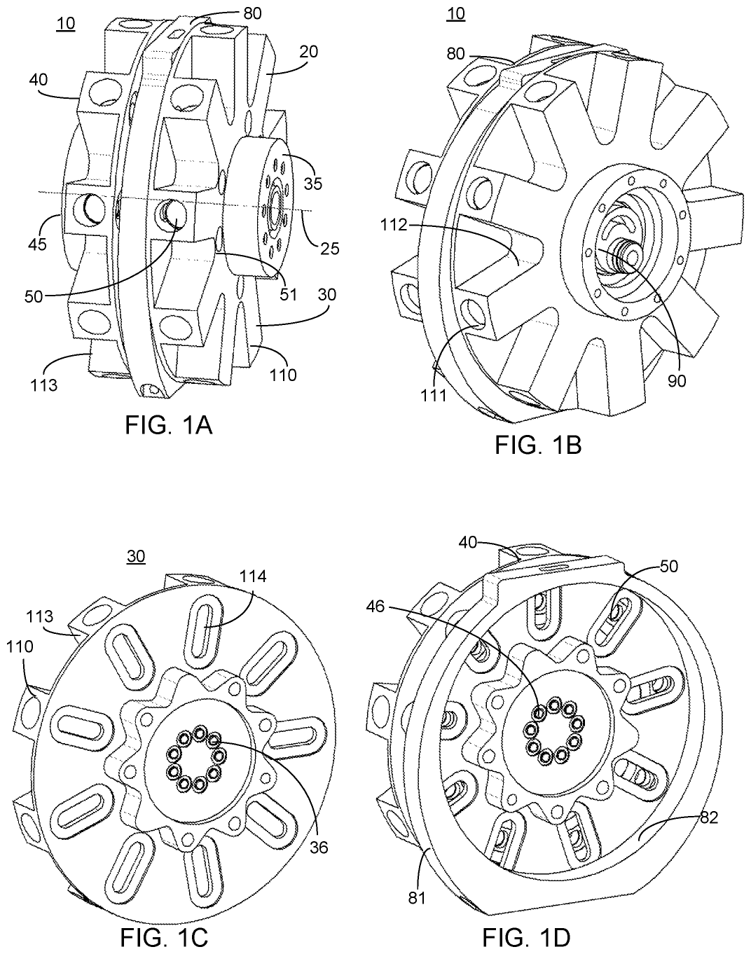

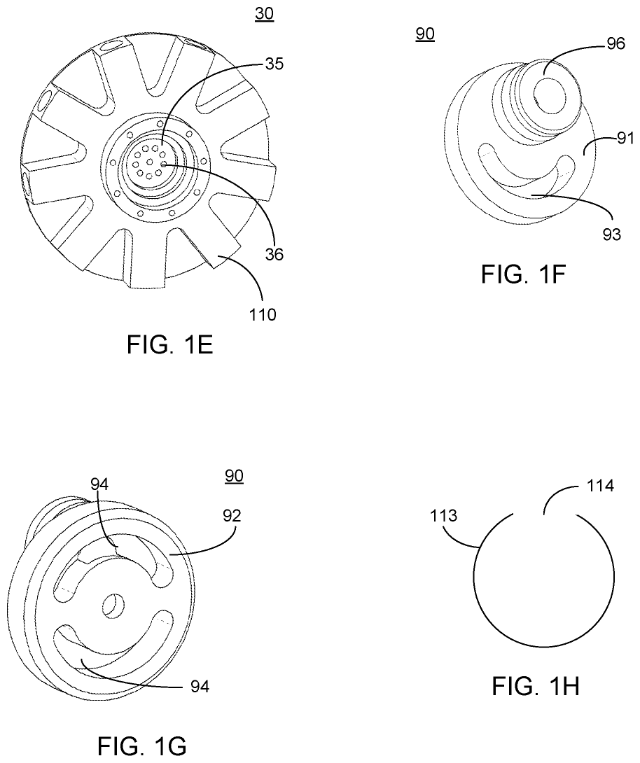

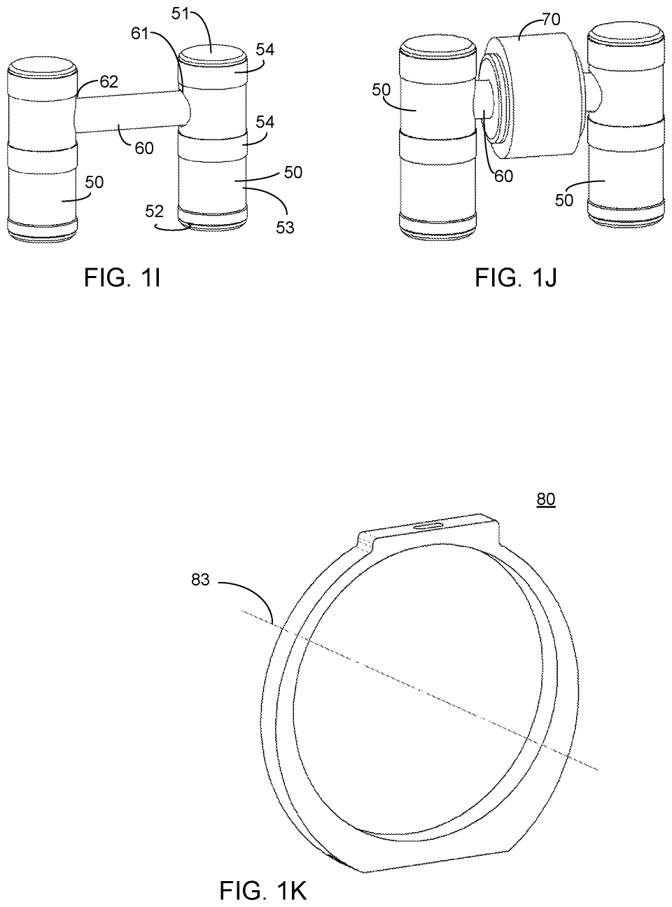

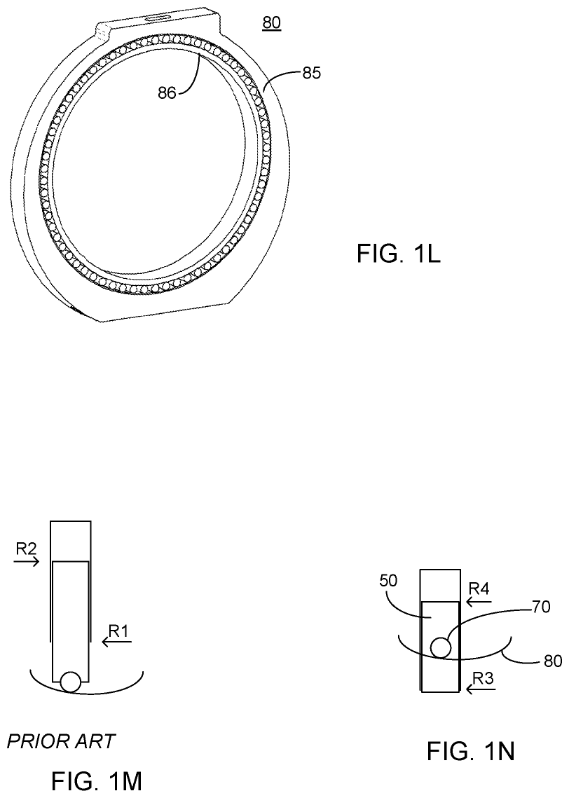

FIGS. 1A-1L illustrate various high level views of a hydraulic assembly 10. Hydraulic assembly 10 comprises: a chamber housing 20, comprising a first section 30 and a second section 40, each exhibiting a center axis 25; a plurality of pistons 50; a plurality of protrusions 60, each exhibiting a first end 61 and a second end 62, second end 62 opposing first end 61; a plurality of contact members 70, each in one embodiment comprising a bearing; a rotational member 80 exhibiting an outer circumference 81, an inner circumference 82 and a center axis 83 of inner circumference 82; and a valve plate 90. FIG. 1A illustrates a high level side view of hydraulic assembly 10; FIG. 1B illustrates a high level perspective view of hydraulic assembly 10; FIG. 1C illustrates a high level perspective view of an inside face of first section 30 of chamber housing 20; FIG. 1D illustrates a high level perspective view of an inside face of second section 40 of chamber housing 20, respective pistons 50 and rotational member 80; FIG. 1E illustrates a high level perspective view of an outside face of first section 30 of chamber housing 20; FIG. 1F illustrates a perspective view of a first face of valve plate 90; FIG. 1G illustrates a perspective view of a second face of valve plate 90; FIG. 1H illustrates a high level side view of a cross-section of a hydraulic chamber; FIG. 1I illustrates a high level perspective view of a pair of pistons 50 connected by a protrusion 60; FIG. 1J illustrates a high level perspective view of a pair of pistons 50 connected by a protrusion 60, protrusion 60 having a contact member 70 thereon; FIG. 1K illustrates a first embodiment of rotational member 80; and FIG. 1L illustrates a second embodiment of rotational member 80, FIGS. 1A-1L being described together.

Rotational member 80 is illustrated and described herein as comprising an eccentric cam ring, i.e. center axis 83 of rotational member 80 is offset from center axis 25 of housing 20 by a predetermined distance, however this is not meant to be limiting in any way. In another embodiment, as will be described below, rotational member 80 comprises a cam exhibiting a plurality of lobes. First section 30 exhibits a center portion 35 and second section 40 exhibits a center portion 45. Although in one embodiment, as described below, rotational member 80 is arranged to rotate, the term ‘rotational’ is not meant to be limiting to such an embodiment. Particularly, in the embodiment of hydraulic assembly 10, rotational member 80 is stationary and first and second sections 30, 40 rotate responsive to force applied to rotational member 80 by pistons 50, as will be described below. Thus, the eccentric position of rotational member 80 is what causes the rotation of first and second sections 30, 40, as will be described below.

Each of first section 30 and second section 40 of chamber housing 20 is generally circular and comprises a plurality of hydraulic chambers 110 situated within the respective one of first section 30 and second section 40. In one embodiment, hydraulic chambers 110 are radially arranged about center portion 35 of first section 30 and center portion 45 of second section 40. In one embodiment, hydraulic chambers 110 are generally evenly spaced. In another non-limiting embodiment, each of first section 30 and second section 40 exhibit 9 hydraulic chambers. Each hydraulic chamber 110 exhibits a first end 111 and a second end 112, second end 112 opposing first end 111. A wall 113 extends from first end 111 to second end 112. Hydraulic chambers 110 are illustrated and described herein as being cylindrical shaped, with a curved wall 113, however this is not meant to be limiting in any way. In another embodiment, hydraulic chambers 110 can be of any appropriate shape for providing hydraulic action, as known to those skilled in the art at the time of the invention. Each hydraulic chamber 110 further exhibits an opening 114 along the length of wall 113 between first end 111 and second end 112. Although opening 114 is illustrated as not reaching first end 111, this is not meant to be limiting in any way. In one embodiment, opening 114 extends along the length of wall 113 all the way to first end 111. In one embodiment, opening 114 exhibits an elongated shape extending along wall 113 such that a majority each hydraulic chamber 110 exhibits a cross-section shaped as a partially open circle, as illustrated in FIG. 1H. In another embodiment, opening 114 does not reach first end 111 of the respective hydraulic chamber. First end 111 of each hydraulic chamber 110 is open so as to receive a respective piston 50, as will be described below. Second end 112 of each hydraulic chamber 110 is closed with an opening 115 extending therethrough to allow hydraulic fluid (not shown) to enter and exit therethrough, as will be described below.

Center portion 35 of first section 30 exhibits a plurality of holes 36 extending therethrough. Each hole 36 further exhibits a port (not shown) with is arranged to mate with an opening 115 of a respective hydraulic chamber 110 of first section 30. Additionally, center portion 45 of second section 40 exhibits a plurality of channels 46, a first end of each channel 46 arranged to mate with a respective hole 36 of first section 30 and a second end of each channel 46 is arranged to mate with an opening 115 of a respective hydraulic chamber of second section 40.

Each piston 50, illustrated in FIG. 1I, exhibits a first end 51 and a second end 52, second end 52 opposing first end 51. Each piston 50 further exhibits a side 53 extending from first end 51 to second end 52. Pistons 50 are illustrated and described herein as being cylindrical shaped, with a curved side 53, however this is not meant to be limiting in any way, and the shape of pistons 50 are designed to correspond to the shape of the respective hydraulic chambers 110 such that hydraulic fluid is maintained between second end 52 of each piston 50 and second end 112 of the respective hydraulic chamber 112, as will be described further below and as is known to those skilled in the art at the time of the invention. In one embodiment, each piston 50 further comprises a pair of rings 54 surrounding curved side 53, thereby reducing friction with the respective hydraulic chamber 110, as will be described below. Although pistons 50 are illustrated herein with rings 54, this is not meant to be limiting in any way. In another embodiment, pistons 50 are provided without rings 54, without exceeding the scope.

Valve plate 90 exhibits: a first face 91; a second face 92 opposing first face 91; an opening 93 extending from first face 91 to second face 92; an opening 94 extending from first face 91 to second face 92; and a port 96 positioned over opening 94. Although hydraulic assembly 10 is illustrated and described herein as comprising valve plate 90, this is not meant to be limiting in any way. In another embodiment, where hydraulic assembly 10 acts as a hydraulic pump, valve plate 90 is replaced with check valves (not shown), as known to those skilled in the art at the time of the invention.

Each of a first set of pistons 50 is positioned within a respective one of the hydraulic chambers 110 of first section 30 of chamber housing 30 and each of a second set of pistons 50 is positioned within a respective one of the hydraulic chambers 110 of second section 40 of chamber housing 30. Each of the first set of pistons 50 is connected to a respective one of the second set of pistons 50 via a respective protrusion 60. Particularly, each protrusion 60 protrudes from curved side 53 of a respective piston 50 of first section 30, at first end 61 thereof, and further protrudes from curved wall 113 of the respective piston of second section 40, at second end 62 thereof, as illustrated in FIG. 1I. Particularly, each protrusion 60 extends from the first of the respective pair of pistons 50, between first end 51 and second end 52 thereof, to the second of the respective pair of pistons 50, between first end 51 and second end 52 thereof, such that first end 61 and second end 62 each extend through opening 114 of the respective hydraulic chamber 110.

Eccentric cam ring 80 is sandwiched between first section 30 and second section 40 of chamber housing 20 such that each protrusion 60 faces inner circumference 82. As described below, in another embodiment eccentric cam ring is provided such that each protrusion 60 faces outer circumference 81. Each contact member 70 is positioned over a respective one of protrusions 60 and is further arranged to contact inner circumference 82 of eccentric cam ring 80. In one embodiment, each contact member 70 is generally circular, as illustrated in FIG. 1J. In one further embodiment, as described above, each contact member 70 is implemented as a bearing. In another embodiment, each contact member 70 is positioned generally in the middle of the respective protrusion 60. Valve plate 90 is positioned over holes 36 of center portion 35 of first section 30.

In operation, hydraulic assembly 10 can be operated as either a hydraulic motor or a hydraulic pump. Particularly, when chamber housing 20 is rotated responsive to high pressure hydraulic fluid entering through valve plate 90, hydraulic assembly 10 is operating as a hydraulic motor. When chamber housing 20 is rotated by an externally applied torque and the rotation thereof outputs high pressure hydraulic fluid through valve plate 90, hydraulic assembly 10 is operating as a hydraulic pump. The below is being described in an embodiment where hydraulic assembly 10 is operating as a hydraulic motor, however this is not meant to be limiting in any way. Particularly, the principle of operation is similar when being operated as a hydraulic pump.

High pressure hydraulic fluid (not shown) enters through port 96 and opening 94 of valve plate 90. The high pressure hydraulic fluid passes into the respective holes 36 and channels 46 into the respective hydraulic chambers 110. Responsive to the high pressure hydraulic fluid, the respective pistons 50 are pushed towards eccentric cam ring 80, thereby applying force thereto. Responsive to the applied force, and due to the eccentricity of eccentric cam ring 80 in relation to center axis 25, first section 30 and second section 40 of chamber housing 20 rotate about center axis 25, as known to those skilled in the art at the time of the invention. Valve plate 90 is held in place by an external housing (not shown), therefore holes 36 rotate in relation to valve plate 90. As chamber housing 20 rotates, different holes 36 line up with opening 94 of valve plate 90 thereby providing high pressure hydraulic fluid to the respective pistons 50 and cause further rotation of chamber housing 20. Additionally, hydraulic chambers 110 which previously received high pressure hydraulic fluid through opening 94 of valve plate 90 now drain low pressure hydraulic fluid through opening 93 of valve plate 90.

Advantageously, applying force via contact members 70 allow for a smaller hydraulic assembly 10. Particularly, in prior art hydraulic assemblies, force is applied by the outer ends of the pistons, as described for example in US patent application publication S/N US 2017/0320542, published Nov. 9, 2017 to Sebhatu, the entire contents of which are incorporated herein by reference. As described therein, force is applied between the piston heads and the outer cam. Similarly, when utilizing an eccentric ring surrounding a plurality of radially arranged pistons, the heads of the pistons push against the eccentric ring to provide rotation. Unfortunately, the force applied between the eccentric ring and the piston head is not directly along a longitudinal axis of the piston and some side forces are also applied. This causes respective forces to be applied at the area where the piston meets the outer edge of the hydraulic chamber and at the point where the farther end of the piston meets the wall of the hydraulic chamber. The reactive forces thus applied to the pistons are given as:

R1+R2=F*((L/a+1)/(L/a−1)) EQ. 1

where R1 is the reactive force at the opening of the hydraulic chamber, R2 is the reactive force at the farther end of the piston, F is the side force applied to the piston when in contact with the eccentric ring, L is length of the piston and a is the distance between the point of contact of the piston with the ring and the opening of the hydraulic chamber, i.e. a is the length of the portion of the piston which is external to the hydraulic chamber, as illustrated in FIG. 1M. Reactive forces R1 and R2 cause friction between the piston and the hydraulic chamber, thereby reducing the efficiency of the hydraulic system. As shown by EQ. 1, in order to reduce the sum of R1 and R2, so as to reduce the friction, L/a needs to be increased. Since a is designed for the desired output of the piston action, increasing L/a requires increasing L, i.e. increasing the length of the piston and the hydraulic chamber. This requires hydraulic chambers with an increased length and an eccentric ring with a larger diameter, thereby causing an overall increase in the size of the hydraulic assembly.

In contrast, applying the force between eccentric cam ring 80 and contact members 70 does not include this limitation. Particularly, protrusions 60 protrude from pistons 50 through openings 114 of hydraulic chambers 110. As a result, the force applied between eccentric cam ring 80 and piston 50 is between first end 111 and second end 112 of hydraulic chamber 110. Thus, the reactive forces applied to piston 50, illustrated in FIG. 1N, are applied in the same direction and their sum is given as:

R3+R4=F EQ. 2

where R3 and R4 are the reactive forces applied between rings 54 of piston 50 and wall 113 of hydraulic chamber 110. As shown in EQ. 2, the sum of the forces is always equal to the side force applied by eccentric cam ring 80, regardless of the length. In an embodiment where rings 54 are not provided, side 53 of pistons 50 applies force to wall 113 of hydraulic chamber 110, the integral of the force being equal to the applied side force from eccentric cam ring 80. Therefore, it is not necessary to provide an increased length of piston 50 outside of the respective hydraulic chamber 110 and the size of hydraulic assembly 10 can be reduced. Additionally, the sum of the reactive forces is always equal to side force F, while in EQ. 1 the sum of the reactive forces is always greater than side force F. Thus, the efficiency of hydraulic assembly 10 is also improved.

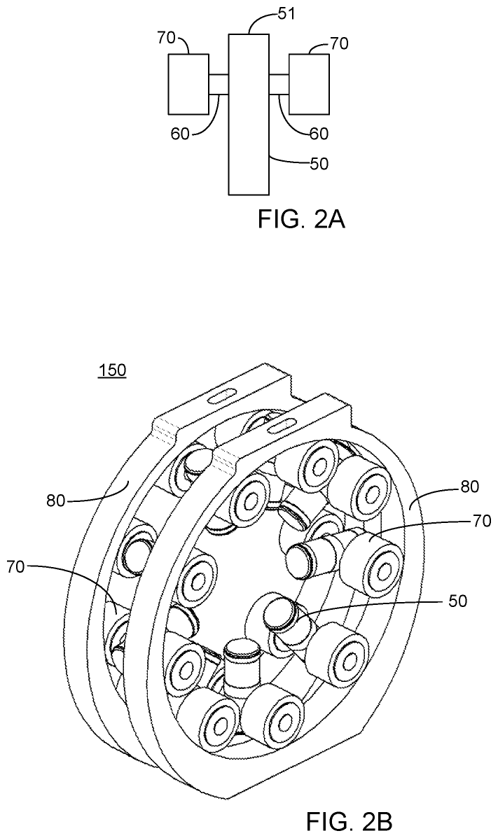

The above has been described in an embodiment where a single eccentric cam ring 80 is provided, however this is not meant to be limiting in any way. In another embodiment, as illustrated in FIGS. 2A-2B, a hydraulic assembly 150 is provided, hydraulic assembly 150 comprising a pair of eccentric cam rings 80 which are provided in parallel and only a single section of chamber housing 20 is provided (not shown for simplicity). Particularly, FIG. 2A illustrates a high level side view of a piston 50 and FIG. 2B illustrates a high level perspective view of hydraulic assembly 150. Each piston 50 exhibits a pair of protrusions 60, extending from opposing sides thereof, each of the pair of protrusions 60 extending through a respective one of a pair of openings in the respective hydraulic chamber (not shown). In one embodiment, a contact member 70 is positioned over each protrusion 60. Eccentric cam rings 80 are positioned in relation to each other such that a space 130 is defined therebetween, the width of space 130 being at least the length of the diameter of the cross section of first end 51 of each of pistons 50 plus the thickness of walls 113. Pistons 50 are each disposed within a respective hydraulic chamber (not shown), as described above, within space 130. The operation is in all respects similar to the operation of hydraulic assembly 10, with the exception that each piston 50 pushes against both eccentric cam rings 80. Providing an eccentric cam ring 80 for each side of piston 50 allows for the above described hydraulic operation while providing a balanced force upon piston 50.

Additionally, the above has been described in an embodiment where rotational member 80 surrounds protrusions 60, such that protrusions 60 are within inner circumference 82, however this is not meant to be limiting in any way. In another embodiment, rotational member 80 exhibits a smaller diameter and is positioned between protrusions 60 such that protrusions 60 come in contact with outer circumference 81.

Furthermore, the above has been described in an embodiment where protrusions 60 contact rotational member 80 via contact members 70 disposed on protrusions 60, however this is not meant to be limiting in any way. In another embodiment, illustrated in FIG. 1L, rotational member 80 comprises an outer ring 85 and a bearing 86 facing inner circumference 82. In such an embodiment, contact members 70 are not provided and protrusions 60 contact bearing 86, which acts instead of contact members 70. Although protrusions 60 are illustrated as being generally cylindrical, however this is not meant to be limiting in any way. In another embodiment, protrusions 60 may be provided in any desired shape, especially when contact members 70 are not provided.

Additionally, the above has been described in an embodiment where hydraulic assembly 10 operates as a motor, however this is not meant to be limiting in any way. In another embodiment, housing 20 is rotated, causing contact members 70 to be pushed by rotational member 80. Responsive to each piston 50 being pushed into the respective hydraulic chambers 110, the hydraulic fluid therein is pushed out of the hydraulic chamber 110 at a high pressure, i.e. hydraulic assembly 10 operates as a pump.

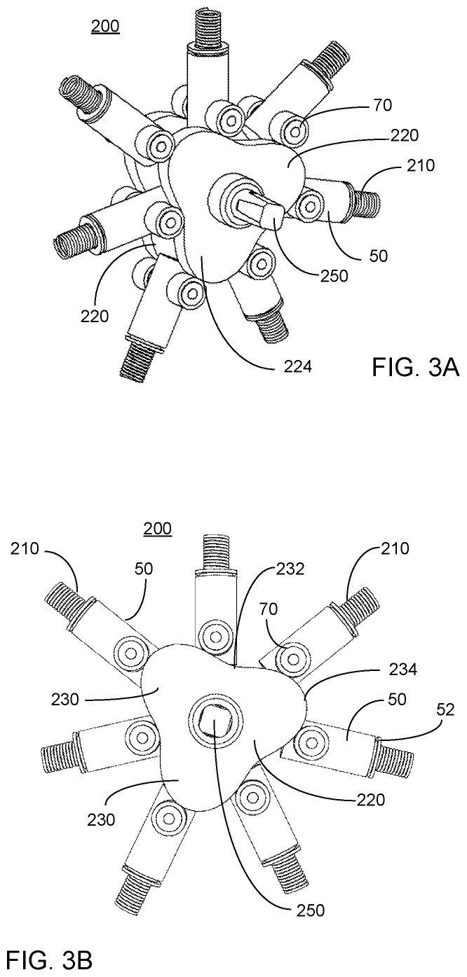

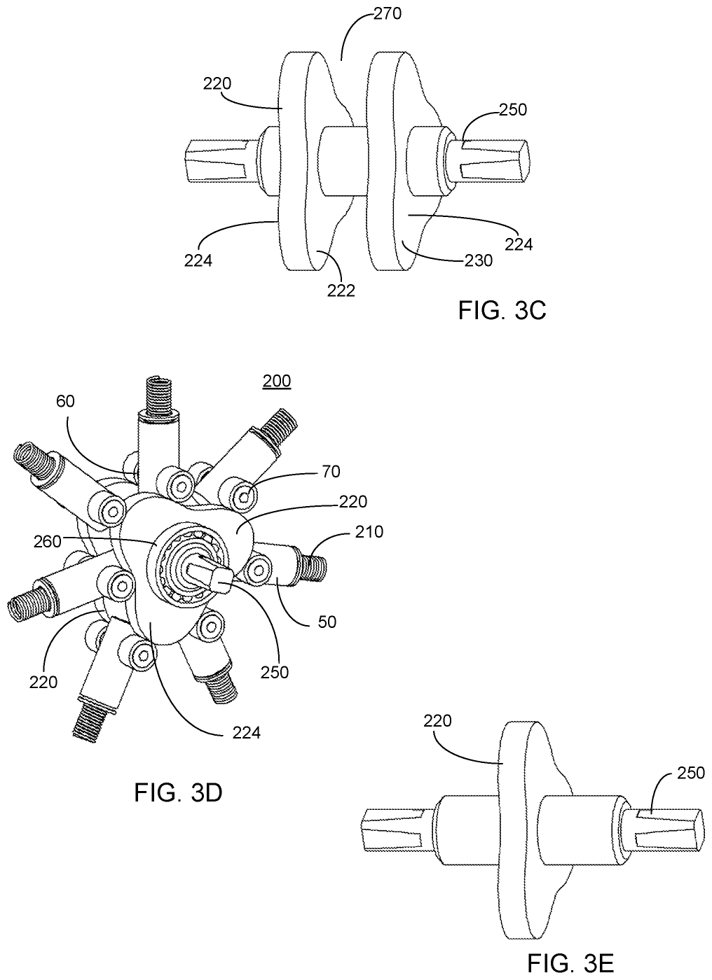

FIGS. 3A-3D illustrate various high level views of a hydraulic assembly 200. Hydraulic assembly 200 comprises: a plurality of pistons 50; a plurality of springs 210; a plurality of pairs of protrusions 60; a plurality of pairs of contact members 70; a pair of rotational members 220, each rotational member 220 exhibiting a plurality of lobes 230, a first face 222 and a second face 224 opposing first face 222; and a rotating shaft 250. In one embodiment, as illustrated in FIG. 3D, hydraulic assembly 200 further comprises a pair of bearings 260. Hydraulic assembly 200 is illustrated as comprising seven pistons 50, however this is not meant to be limiting in any way and any number of pistons 50, may be provided, with the minimum being two pistons 50. Rotational member 220 is illustrated and described herein as a cam positioned in the center of an array of pistons 50, however this is not meant to be limiting in any way. In another embodiment, cam 220 is provided as a ring cam enclosing pistons 50 from the outside, as described above in relation to eccentric cam rings 80. In another embodiment, an eccentric ring is provided. FIGS. 3A and 3D each illustrate a respective high level perspective view of hydraulic assembly 200, FIG. 3B illustrates a high level side view of hydraulic assembly 200 and FIG. 3C illustrates a high level perspective view of cams 220 and rotating shaft 250, FIGS. 3A-3D being described together.

In one non-limiting embodiment, cam 220 comprises 3 lobes 230. In another embodiment, each lobe 230 exhibits a generally oval shape. Each lobe 230 rises from a base 232 to an apex 234 thereof. As described above, a first of each pair of protrusions protrudes from one side of a respective piston 50 and a second of each pair of protrusions protrudes from the opposing side of the respective piston 50. As further described above, each contact member 70 is positioned over a respective protrusion 60. As further described above, each piston 50 is positioned within a respective hydraulic chamber 110 (not shown for simplicity).

Second end 52 of each piston 50 has attached thereto a respective spring 210, the respective spring 210 coupling piston 50 to second end 112 of the respective hydraulic chamber 110. Each cam 220 is positioned on rotating shaft 250, with first face 222 of the first cam 220 facing first face 222 of the second cam 220. Cams 220 are spaced apart such that a space 270 is defined between the planes defined by first faces 222 of cams 220. Pistons 50 are positioned between cams 220, i.e. within space 270. Pistons 50 are positioned such that each contact member 70 comes in contact with lobes 230 of a respective cam 220, as described above in relation to hydraulic assembly 150. A first bearing 260 is positioned on rotating shaft 250 adjacent to second face 224 of the first cam 220 and the second bearing 260 is positioned on rotating shaft 250 adjacent to second face 224 of the second cam 220.

In operation, rotating shaft 250 is rotated by an external torque, optionally by a rotation of bicycle pedals. The rotation of rotating shaft 250 causes cams 220 to rotate. As cams 220 rotate, contact members 70 of each pair of pistons 50 are pushed by the rise of each lobe 230 when in contact therewith. When rising, each piston 50 pushes out high pressure hydraulic fluid from the respective hydraulic chamber 110 (not shown for simplicity). Additionally, the respective spring 210 is compressed. After passing apex 234 of lobe 230, each spring 210 rapidly pushes the respective piston 50 towards base 232. The plurality of lobes 230 provides for a plurality of cycles of high pressure fluid output during each revolution thereby increasing the output of hydraulic assembly 200 for each revolution.

The above has been described as an operation of a hydraulic pump, however this is not meant to be limiting in any way. In another embodiment, high pressure hydraulic fluid is provided to each piston 50 from an external hydraulic pump, each piston 50 applying force to cams 220 responsive to the received high pressure hydraulic fluid. When a piston 50 pushes against any of lobes 230, cam 220 is rotated. When the input of high pressure hydraulic fluid ends and the respective hydraulic chamber connects to the low pressure outlet, the piston 50 is pushed back by the next lobe 230.

The above has been described in an embodiment where a pair of cams 220 are provided and a pair of protrusions 60 are provided for each piston 50, however this is not meant to be limiting in any way. As described above in relation to hydraulic assembly 10, in another embodiment the hydraulic pump is provided with a single cam 220, as illustrated in FIG. 3E, and a plurality of pair of pistons 50 (not shown), each pair of pistons 50 connected by a respective protrusion 60.

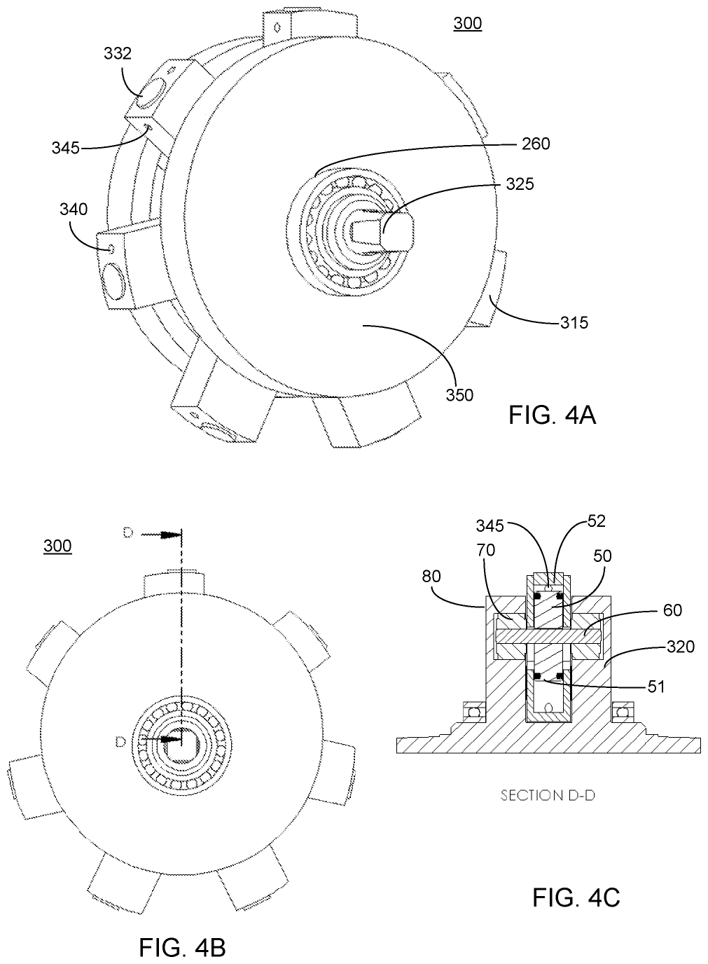

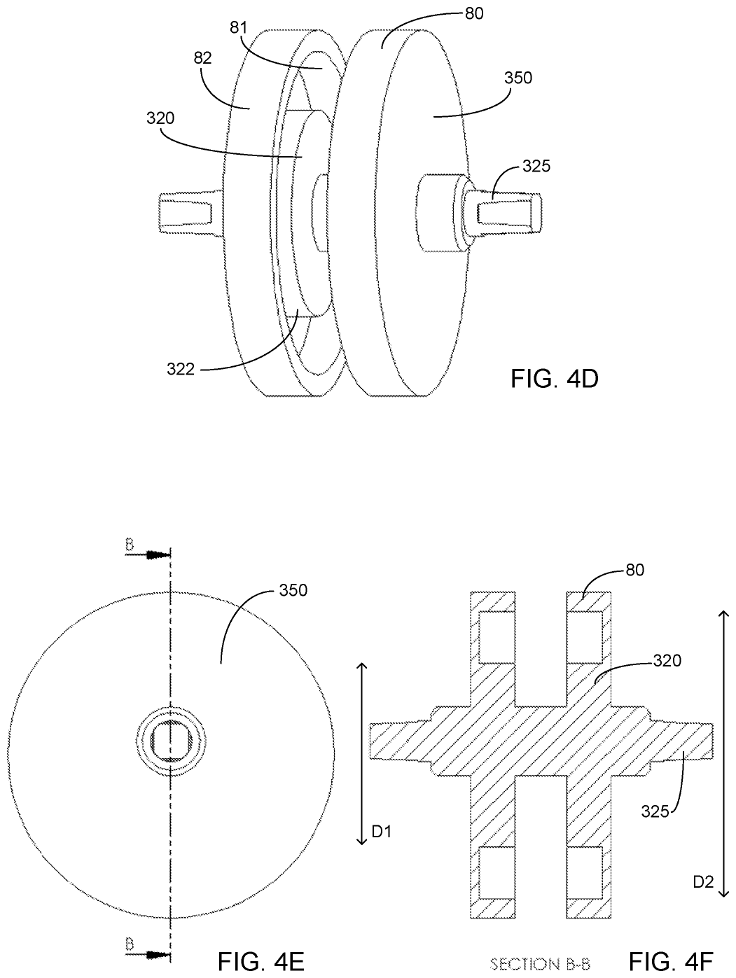

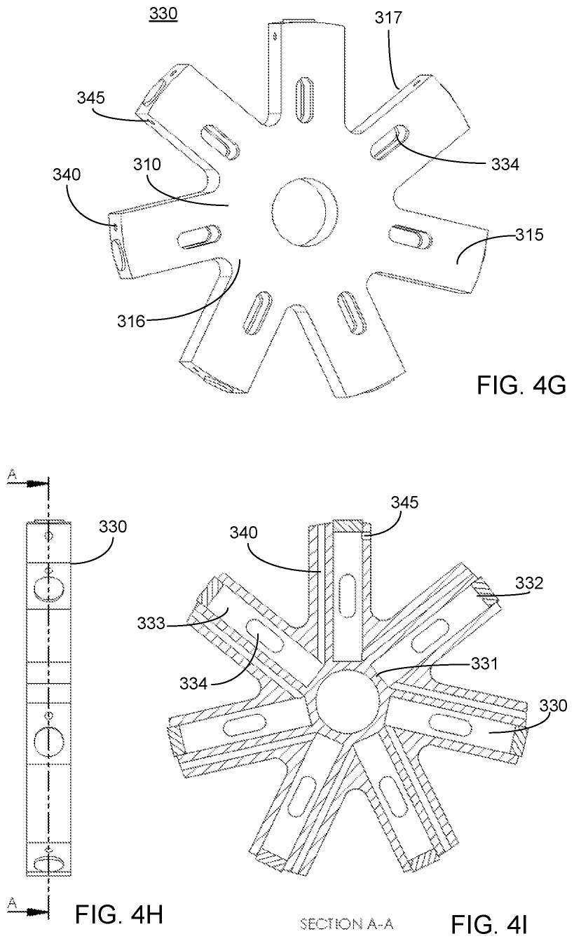

FIGS. 4A-41 illustrate various high level views of a hydraulic assembly 300 providing double hydraulic action. Hydraulic assembly 300 comprises: a chamber housing 310 comprising a plurality of arms 315 and exhibiting a first face 316 and a second face 317, second face 317 opposing first face 316; a plurality of pistons 50; a plurality of protrusions 60; a plurality of contact members 70; a pair of outer rotational members 80; a pair of inner rotational members 320, each exhibiting an outer circumference 322; a shaft 325; and a pair of bearings 260.

FIG. 4A illustrates a high level perspective view of hydraulic assembly 300, FIG. 4B illustrates a high level side view of hydraulic assembly 300, FIG. 4C illustrates a cut-away section of hydraulic assembly 300, FIG. 4D illustrates a high level perspective view of outer rotational members 80 and inner rotational members 320, FIG. 4E illustrates a high level side view of outer rotational members 80 and inner rotational members 320, FIG. 4F illustrates a cut-away section of outer rotational members 80 and inner rotational members 320, FIG. 4G illustrates a high level perspective view of chamber housing 310, FIG. 4H illustrates a high level side view of chamber housing 310 and FIG. 4I illustrates a cut-away section of chamber housing 310.

Each arm 315 exhibits a respective hydraulic chamber 330, as described above in relation to hydraulic assembly 10, a respective fluid channel 340 and a respective fluid channel 345. As described above in relation to hydraulic chambers 110, each hydraulic chamber 330 exhibits a first end 331 and a second end 332, second end 332 opposing first end 331. A wall 333 extends from first end 331 to second end 332. Each hydraulic chamber 330 further exhibits a pair of openings 334 along the length of opposing sides of wall 333 between first end 331 and second 332, as described above in relation to opening 114. Particularly, a first opening 334 extends through first face 316 of chamber housing 310 and a second opening 334 extends through second face 317 of chamber housing 310.

As described above in relation to hydraulic assembly 150, a respective pair of protrusions 60 extend from opposing sides of each piston 50, a respective contact member 70 positioned over each protrusion 60. Each piston 50 is positioned within a respective hydraulic chamber 330, first end 51 facing first end 331 and second end 52 facing second end 332. A first protrusion 60 protrudes from a first opening 334 and a second protrusion 60 protrudes from a second opening 334.

Inner rotational members 320 and outer rotational members 80 are each eccentric in relation to shaft 325, i.e. the center axes thereof (not shown) are offset from the longitudinal axis of shaft 325 (not shown) by a predetermined distance, as described above. Each inner rotational member 320 exhibits a diameter D1 and each inner circumference 81 of outer rotational member 80 exhibits a diameter D2, diameter D2 greater than diameter D1. A first outer rotational member 80 faces first face 316 of chamber housing 310 and the second outer rotational member 80 faces second face 317 of chamber housing 310. A first inner rotational member 320 faces first face 316 of chamber housing 310 and the second inner rotational member 320 faces second face 317 of chamber housing 310. Inner circumference 81 of each outer rotational member 80 faces outer circumference 322 of the respective inner rotational member 320. In one embodiment, a pair of side walls 350 are further provided. First inner rotational member 320 and first outer rotational member 80 are disposed on a face of a first side wall 350. Second inner rotational member 320 and second outer rotational member 80 are disposed on a face of the second side wall 350. Optionally, each set of side wall 350, inner rotational member 320 and outer rotational member 80 is formed of a single solid body. Inner rotational members 320 and outer rotational members 80 are positioned such that contact members 70 are sandwiched between inner circumference 81 of the respective outer rotational member 80 and outer circumference 322 of the respective inner rotational member 320.

Each fluid channel 340 extends through the respective arm 315 and reaches first end 331 of the hydraulic chamber 330 of an adjacent arm 315. Hydraulic fluid (not shown) fills the space between first end 51 of piston 50 and first end 331 of hydraulic chamber 330, and further fills the respective fluid channel 340. Each fluid channel 345 extends through a portion of the respective arm 315 until reaching second end 332 of the hydraulic chamber 330 of the respective arm 315. Hydraulic fluid fills the space between second end 52 of piston 50 and second end 332 of hydraulic chamber 330, and further fills the respective fluid channel 345. A hydraulic fluid transport system (not shown), including check valves, a valve plate, an electrical valve or other appropriate hydraulic mechanisms, is coupled to each fluid channel 340 and each fluid channel 345.

As described above in relation to rotating shaft 250 of hydraulic assembly 200, shaft 325 extends through chamber housing 310 and side walls 350. A first bearing 260 is positioned over shaft 325 and faces first side wall 350. The second bearing 260 is positioned over shaft 325 and faces second side wall 350.

The operation of hydraulic assembly 300 will be described herein as a hydraulic pump, however this is not meant to be limiting in any way. In another embodiment, hydraulic assembly 300 is operated as a hydraulic motor. In operation, shaft 325 is rotated, thereby rotating inner rotational members 320 and outer rotational members 80. The eccentric positions of each of inner rotational members 320 and outer rotational members 80 are arranged such that a force is provided to each piston 50 in the direction of first end 331 of the respective hydraulic chamber 330 during one half of the rotation cycle and a force is provided in the direction of second 332 during the second half of the rotation cycle. Thus, high pressure hydraulic fluid is output from each hydraulic chamber 330 for the entirety of the rotation cycle, the high pressure output half of the time through fluid channel 340 and the other half of the time through fluid channel 345. Particularly, as the distance from shaft 325 and outer circumference 322 of each inner rotational member 320 decreases, thereby ending the force applied by inner rotational members 320 to pistons 50, the distance from shaft 325 and inner circumference 81 of outer rotational member 80 also decreases, thereby beginning the force applied by outer rotational members 80 to pistons 50. Advantageously, the double action of hydraulic assembly 300 provides increased displacement. As a result, pistons 50 and hydraulic chambers 330 with a shorter length and/or diameter can be used. Additionally, the number of pistons 50 and hydraulic chambers 330 can be reduced. Therefore, the overall size and weight of hydraulic assembly 300 is reduced. Additionally, there is no need for springs, as described above in relation to hydraulic assembly 200, due to the double action of inner rotational member 320 and outer rotational member 80.

Although the above has been described in relation to eccentric inner rotational members 320 and outer rotational members 80, this is not meant to be limiting in any way. In another embodiment, inner rotational member 320 exhibits a plurality of lobes, as described above in relation to hydraulic assembly 200 and outer rotational member 80 exhibits a plurality of lobes which complement the lobes of inner rotational member 320.

FIG. 5 illustrates a high level schematic diagram of a portion of a hydraulic bicycle 400, the portion of hydraulic bicycle 400 comprising: a frame 410; a hydraulic pump 420; a pair of pedals 430; a hydraulic motor 440; and a back wheel 450. Hydraulic pump 420 in one embodiment comprises one of hydraulic assemblies 10, 150 and 200, as described above. In another embodiment, hydraulic pump 420 comprises a standard hydraulic pump, known to the prior art. Rotating pedals 430 operates the pump of hydraulic pump 420, which provides high pressure hydraulic fluid through hydraulic tubing (not shown) to hydraulic motor 440. In one embodiment, hydraulic motor 440 comprises one of hydraulic assemblies 10 and 150 described above. Responsive to the received high pressure hydraulic fluid, hydraulic motor 440 rotates back wheel 450, thereby advancing the bicycle. As known to those skilled in the art at the time of the invention, a seat, front wheel, handle bars, brakes, hydraulic fluid transport mechanisms and other bicycle components are further provided in the bicycle. In another embodiment (not shown), an electric motor is further provided, the bicycle being operated by a combination of electric and human power, while utilizing the hydraulic system.

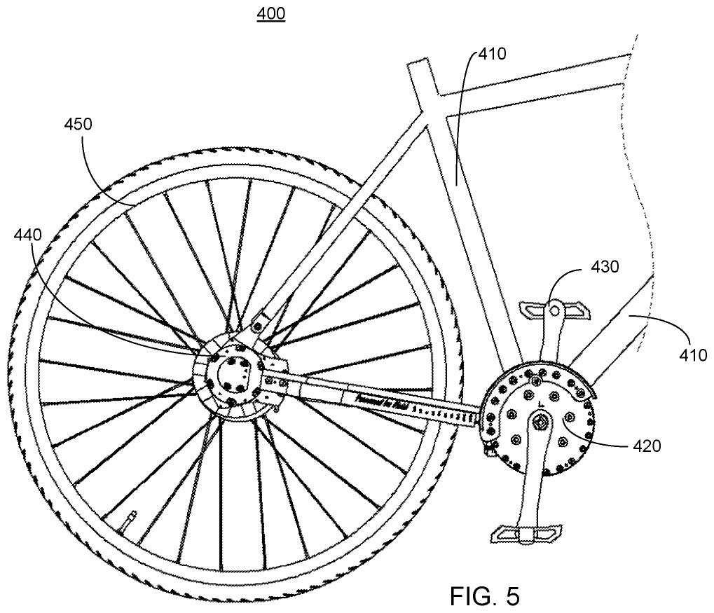

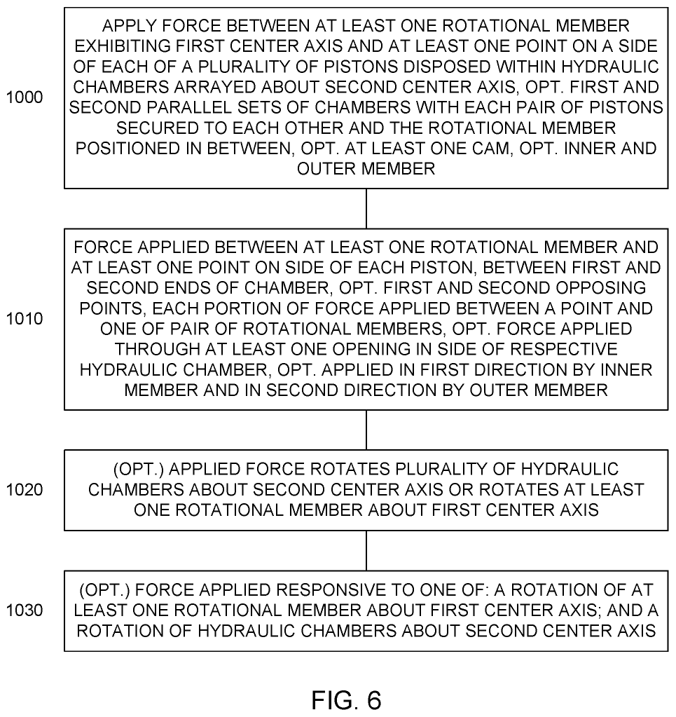

FIG. 6 illustrates a high level flow chart of a hydraulic rotation method, in accordance with certain embodiments. In stage 1000, a force is applied between each of a plurality of pistons and at least one rotational member, the at least one rotational member exhibiting a first center axis. Optionally, the at least one rotational member comprises at least one cam, further optionally a ring cam. Each of the plurality of pistons is disposed within a respective one of a plurality of hydraulic chambers, the plurality of hydraulic chambers arrayed about a second center axis.

Optionally the plurality of hydraulic chambers comprises a first set of hydraulic chambers arrayed about the second center axis and a second set of hydraulic chambers arrayed about the second center axis such that each of the first set of hydraulic chambers is generally parallel to a respective one of the second set of hydraulic chambers. The piston of each of the first set of hydraulic chambers is secured to the piston of the respective one of the second set of hydraulic chambers. In such an embodiment, the at least one rotating member is a single rotational member positioned between the pistons of the first set of hydraulic chambers and the pistons of the second set of hydraulic chambers. Optionally, at least one inner rotational member and at least one outer rotational member are provided.

In stage 1010, the force of stage 1000 is applied between the at least one rotational member and at least one point on a side of each of the plurality of pistons, the at least one point being between a first end and second end of the respective one of the plurality of hydraulic chambers. Optionally, the at least one point comprises a first point and a second point, the second point opposing the first point. In such an embodiment, the at least one rotational member comprises a pair of rotational members positioned in parallel to each other, the plurality of pistons positioned between the pair of rotational members such that a first portion of the force is applied between a first of the pair of rotational members and the first point of each of the plurality of pistons. A second portion of the force is applied between a second of the pair of rotational members and the second point of each of the plurality of pistons. Thus, a generally equal force is applied on both sides of the piston to maintain balance.

Optionally, the force is applied through at least one opening in a side of the respective hydraulic chamber. Further optionally, the force is applied via at least one protrusion protruding from the respective piston through the at least one opening of the respective hydraulic chamber. In the embodiment where a first portion of the force is applied to a first point and a second portion of the force is applied to a second point, the first portion of the force is applied via a first protrusion extending through a first opening and the second portion of the force is applied via a second protrusion extending through a second opening.

In the embodiment where at least one inner rotational member and at least one outer rotational member are provided, the force is applied to each piston by the at least one inner rotational member in a first direction during a first half of the rotation cycle and the force is applied to each piston by the at least one outer rotational member in a second direction during the second half of the rotation cycle.

In optional stage 1020, the applied force of stage 1010 rotates the plurality of hydraulic chambers about the second center axis. Particularly, the plurality of pistons of stage 1000 push against the at least one rotational member of stage 1000, which is preferably fixed, the first center axis of the at least one rotational member being offset from the second center axis the plurality of hydraulic chambers, thereby causing the plurality of hydraulic chambers to rotate about the second center axis. Alternatively, the applied force rotates the at least one rotational member about the first center axis. Particularly, the plurality of pistons, whose hydraulic chambers are preferably fixed, push against the at least one rotational member thereby causing the at least one rotational member to rotate about the first center axis. Thus, in optional stage 1020, the described method enacts a hydraulic motor.

In optional stage 1030, the force of stage 1010 is applied responsive to one of: a rotation of the at least one rotational member of stage 1000 about the first center axis, i.e. the rotating at least one rotational member pushes each of the plurality of pistons of stage 1000 into the respective hydraulic chamber of stage 1000; and a rotation of the plurality of hydraulic chambers about the second center axis, i.e. the rotating pistons come in contact with the at least one rotational member, thereby causing the pistons to be pushed into the respective hydraulic chambers. Thus, in optional stage 1030, the described method enacts a hydraulic pump.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

1. A hydraulic assembly comprising:
at least one rotational member exhibiting a first center axis;
a plurality of hydraulic chambers arrayed about a second center axis, each of said plurality of hydraulic chambers exhibiting a first end facing said second center axis, a second end opposing said first end, a wall extending from said first end to said second end and at least one opening along said wall between said first end and said second end; and
a plurality of pistons, each exhibiting a first end a second end and a side extending from said first end to said second end, each of said plurality of pistons positioned within a respective one of said plurality of hydraulic chambers,
wherein each of said plurality of pistons further comprises at least one protrusion protruding from said side of said piston, said at least one protrusion of each of said plurality of pistons extending through said at least one opening of said respective hydraulic chamber and arranged to contact said at least one rotational member such that a force is applied between said at least one rotational member and said respective piston.

2. The hydraulic assembly of claim 1, wherein said applied force rotates said plurality of hydraulic chambers about said second center axis or rotates said at least one rotational member about said first center axis.

3. The hydraulic assembly of claim 1, wherein said force is applied responsive to one of:
a rotation of said at least one rotational member about said first center axis; and
a rotation of said plurality hydraulic chambers about said second center axis.

4. The hydraulic assembly of claim 1, wherein said at least one protrusion of each of said plurality of pistons contacts said at least one rotating member between said first end and said second end of said respective hydraulic chamber.

5. The hydraulic assembly of claim 1, wherein said at least one rotational member comprises at least one cam.

6. The hydraulic assembly of claim 1, wherein said plurality of hydraulic chambers comprises a first set of hydraulic chambers arrayed about said second center axis and a second set of hydraulic chambers arrayed about said second center axis such that each of said first set of hydraulic chambers is generally parallel to a respective one of said second set of hydraulic chambers, and
wherein said piston of each of said first set of hydraulic chambers is secured to said piston of said respective one of said second set of hydraulic chambers, said at least one rotational member positioned between said pistons of said first set of hydraulic chambers and said pistons of said second set of hydraulic chambers.

7. The hydraulic assembly of claim 6, wherein said piston of each of said first set of hydraulic chambers is secured to said piston of said respective one of said second set of hydraulic chambers via said respective protrusions.

8. The hydraulic assembly of claim 1, wherein said at least one opening of each of said plurality of hydraulic chambers comprises a first opening and a second opening, said second opening opposing said first opening,
wherein said at least one protrusion of each of said plurality of pistons comprises a first protrusion and a second protrusion, said second protrusion opposing said first protrusion, said first protrusion protruding through said first opening of said respective hydraulic chamber and said protrusion protruding through said second opening of said respective hydraulic chamber, and
wherein said at least one rotational member comprises a pair of rotational members positioned in parallel to each other, said plurality of pistons positioned between said pair of rotational members such that said first protrusion of each of said plurality of pistons is arranged to come in contact with a first of said pair of rotating members and said second protrusion of each of said plurality of pistons is arranged to come in contact with a second of said pair of rotating members.

9. The hydraulic assembly of claim 1, wherein said at least one protrusion of each of said plurality of pistons comprises a generally circular shaped portion, said contact with said at least one rotating member being via said generally circular shaped portion.

10. The hydraulic assembly of claim 1, wherein said at least one rotational member comprises a first rotational member and a second rotational member, and
wherein said at least one protrusion of each of said plurality of pistons is arranged to contact said first rotational member such that a force is applied between said first rotational member and said respective piston in a first direction and said at least one protrusion of each of said plurality of pistons is arranged to contact said second rotational member such that a force is applied between said second rotational member and said respective piston in a second direction, said second direction generally opposing said first direction.

11. A hydraulic rotation method for rotating at least one rotational member about a first center axis or rotating a plurality of hydraulic chambers about a second center axis, the plurality of hydraulic chamber arrayed about the second center axis, each of the plurality of hydraulic chambers having disposed therein a respective one of a plurality of pistons, the method comprising applying a force between each of the plurality of pistons and the at least one rotational member,
wherein said force is applied between the at least one rotational member and at least one point on a side of each of the plurality of pistons, the at least one point being between a first end and second end of the respective one of the plurality of hydraulic chambers.

12. The method of claim 11, said applied force rotates the plurality of hydraulic chambers about said second center axis or rotates said at least one rotational member about said first center axis.

13. The method of claim 11, wherein said force is applied responsive to one of:
a rotation of said at least one rotational member about said first center axis; and
a rotation of said plurality hydraulic chambers about said second center axis.

14. The method of claim 1, wherein the at least one rotational member comprises at least one cam.

15. The method of claim 1, wherein, for each of the plurality of pistons, said force is applied through at least one opening in a side of the respective hydraulic chamber.

16. The method of claim 1, wherein, for each of the plurality of pistons, said force is applied via at least one protrusion protruding from the respective piston through the at least one opening of the respective hydraulic chamber.

17. The method of claim 1, wherein the plurality of hydraulic chambers comprises a first set of hydraulic chambers arrayed about the second center axis and a second set of hydraulic chambers arrayed about the second center axis such that each of the first set of hydraulic chambers is generally parallel to a respective one of the second set of hydraulic chambers, and
wherein the piston of each of the first set of hydraulic chambers is secured to the piston of the respective one of the second set of hydraulic chambers, the at least one rotating member positioned between the pistons of the first set of hydraulic chambers and the pistons of the second set of hydraulic chambers.

18. The method of claim 1, wherein said at least one point comprises a first point and a second point, the second point opposing the first point,
wherein the at least one rotational member comprises a pair of rotational members positioned in parallel to each other, the plurality of pistons positioned between the pair of rotational members such that a first portion of said force is applied between a first of the pair of rotational members and the first point of each of the plurality of pistons and a second portion of said force is applied between a second of the pair of rotational members and the second point of each of the plurality of pistons.

19. The method of claim 1, wherein the at least one rotational member comprises a first rotational member and a second rotational member, and
wherein said force is applied by the first rotational member in a first direction and is applied by the second rotational member in a second direction, the second direction generally opposing the first direction.
